(19) United States
(12) Patent Application Publication
(10) Pub. No.: US 2019/0086086 A1
(43) Pub. Date: Mar. 21, 2019

(54) CAVITY STABILIZED DETONATION COMBUSTOR ASSEMBLY OF A ROTATING DETONATION ENGINE

(71) Applicant: General Electric Company, Schenectady, NY (US)

(72) Inventors: Venkat Eswarlu Tangirala, Niskayuna, NY (US); Anthony Dean, Niskayuna, NY (US); Narendra Digamber Joshi, Niskayuna, NY (US); Sarah Monahan, Latham, NY (US)

(21) Appl. No.: 15/711,742

(22) Filed: Sep. 21, 2017

(51) Int. Cl. F23R 3/04; F23R 7/00; F02C 5/04; F02C 3/16

(52) U.S. Cl. CPC F23R 3/04; F02C 3/16; F02C 5/04; F23R 7/00

(57) ABSTRACT

A cavity stabilized detonation combustor assembly for a rotating detonation engine includes opposing inner and outer walls that are radially spaced apart from each other and that both extend around a center axis of the rotating detonation engine. Detonations in the rotating detonation engine rotate around the center axis of the rotating detonation engine. The assembly also includes opposing leading and trailing cavity walls that are coupled with the inner and outer walls and which radially extend away from the center axis, and an axial wall that is coupled with and connects the leading and trailing cavity walls with each other. The axial wall and the leading and trailing cavity walls define a detonation stabilizing cavity in which detonations of the rotating detonation engine occur and are stabilized.

### FIELD

The present subject matter relates generally to a combustor of an engine, such as a rotating detonation engine.

### BACKGROUND

A rotating detonation engine includes an annulus with an inlet end through which a fresh fuel and air mixture enters and an outlet end from which exhaust exits. A detonation wave travels in a circumferential direction of the annulus and consumes the incoming fuel and air mixture. The burned fuel and air mixture (e.g., combustion gases) exits the annulus and is exhausted with the exhaust flow.

The detonation wave provides a high-pressure region in an expansion region of the combustion. Rotating detonation pressure gain combustion systems are expected to have significant advantages over pulse detonation pressure gain combustors as the net non-uniformity of flow entering a turbine in these systems is expected to be lower by a factor of two to ten.

### SUMMARY

In one embodiment, a cavity stabilized detonation combustor assembly for a rotating detonation engine includes opposing inner and outer walls that are radially spaced apart from each other and that both extend around a center axis of the rotating detonation engine. Detonations in the rotating detonation engine rotate around the center axis of the rotating detonation engine. The assembly also includes opposing leading and trailing cavity walls that are coupled with the inner and outer walls and which radially extend away from the center axis, and an axial wall that is coupled with and connects the leading and trailing cavity walls with each other. The axial wall and the leading and trailing cavity walls define a detonation stabilizing cavity in which detonations of the rotating detonation engine occur and are stabilized.

In one embodiment, a cavity stabilized detonation combustor assembly for a rotating detonation engine includes opposing inner and outer walls that are radially spaced apart from each other and that both extend around a center axis of the rotating detonation engine. Detonations in the rotating detonation engine rotate around the center axis of the rotating detonation engine. The assembly also includes opposing leading and trailing cavity walls that are coupled with the inner and outer walls and which radially extend away from the center axis, and an axial wall that is coupled with and connects the leading and trailing cavity walls with each other. The axial wall includes fuel openings through which fuel is injected into the detonation stabilizing cavity and air openings through which air is injected into the detonation stabilizing cavity. The air openings are oriented to direct the air into the detonation stabilizing cavity in tangential directions that rotate the air in the detonation stabilizing cavity around the center axis of the rotating detonation engine.

In one embodiment, a cavity stabilized detonation combustor assembly for a rotating detonation engine includes opposing inner and outer walls that are radially spaced apart from each other and that both extend around a center axis of the rotating detonation engine. Detonations in the rotating detonation engine rotate around the center axis of the rotating detonation engine. The assembly also includes opposing leading and trailing cavity walls that are coupled with the inner and outer walls and which radially extend away from the center axis, and an axial wall that is coupled with and connects the leading and trailing cavity walls with each other. The inner and outer walls have a tapered shape with the inner and outer walls being spaced apart by a larger distance at leading ends of the inner and outer walls than at opposite trailing ends of the inner and outer walls.

These and other features, aspects and advantages of the present inventive subject matter will become better understood with reference to the following description and appended claims. The accompanying drawings, which are incorporated in and constitute a part of this specification, illustrate embodiments of the inventive subject matter and, together with the description, serve to explain the principles of the inventive subject matter.

### BRIEF DESCRIPTION OF THE DRAWINGS

A full and enabling disclosure of the inventive subject matter, including the best mode thereof, directed to one of ordinary skill in the art, is set forth in the specification, which makes reference to the appended figures, in which:

FIG. 1 illustrates one example of a rotating detonation engine;

FIG. 2 illustrates a cross-sectional view of a cavity stabilized detonation combustor assembly of a rotating detonation engine according to one embodiment of the inventive subject matter described herein;

FIG. 3 illustrates a perspective view of a portion of the combustor assembly shown in FIG. 2;

FIG. 4 illustrates a cross-sectional view of the combustor assembly shown in FIG. 2; and

FIG. 5 illustrates a flowchart of one embodiment of a method for providing a cavity stabilized detonation combustor assembly of a rotation detonation engine.

### DETAILED DESCRIPTION

Reference will now be made in detail to present embodiments of the inventive subject matter, one or more examples of which are illustrated in the accompanying drawings. The detailed description uses numerical and letter designations to refer to features in the drawings. Like or similar designations in the drawings and description have been used to refer to like or similar parts of the inventive subject matter. As used herein, the terms “first”, “second”, and “third” may be used interchangeably to distinguish one component from another and are not intended to signify location or importance of the individual components.

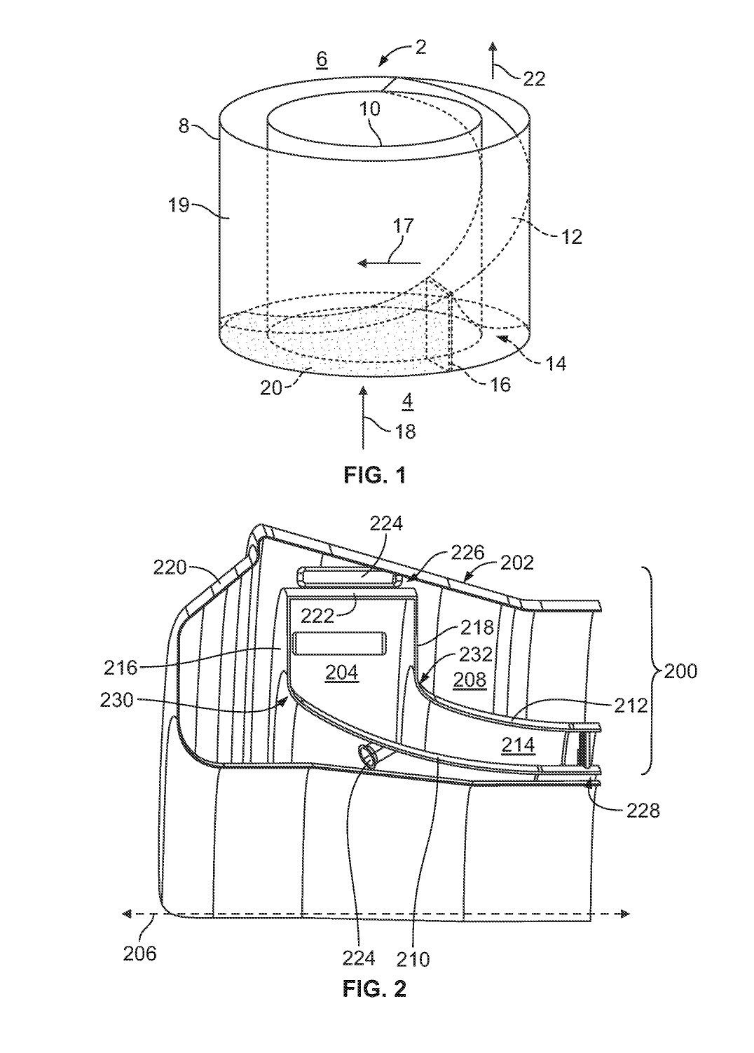

FIG. 1 illustrates one example of a rotating detonation engine 2. The engine 2 includes an annulus having an outer wall 8 and an inner wall 10. The annulus that is defined by the walls 8, 10 has an inlet end 4 (in which a fresh fuel/air mixture 18 enters) and an outlet end 6 from which an exhaust flow 22 exits the engine 2. A detonation wave 16 travels in a circumferential direction 17 of the annulus (and around a center axis of the annulus), thereby consuming the incoming fuel/air mixture 18 and providing a high-pressure region 14 in an expansion region 12 of the combustion. The burned fuel/air mixture (e.g., combustion gases) 19 exit the annulus and are exhausted with the exhaust flow 22. The region 14 behind the detonation wave 16 has very high pressures and this pressure can feed back into an upstream chamber from which the air and fuel are introduced and form an unburnt fuel/air mixture 18.

FIG. 2 illustrates a cross-sectional view of a cavity stabilized detonation combustor assembly 200 of a rotating detonation engine 202 according to one embodiment of the inventive subject matter described herein. The combustor assembly 200 can be used in rotating detonation engines or systems, such as the engine or system 2 shown in FIG. 1 or in another rotating detonation engine or system. The combustor assembly 200 operates to stabilize combustion of the fuel and air mixture 18 (shown in FIG. 1) within a cavity 204 of the combustor assembly 200, while optionally having a smaller size than other combustor assemblies (thereby reducing residence times of the mixture 18 in the combustor assembly 200). The detonation occurring within the cavity 204 of the combustor assembly 200 rotates about or around a center axis 206 of an annulus defined by the combustor assembly 200, and optionally can operate without (or eliminate the need for) a stage one nozzle in the engine 202 downstream of the combustor assembly 200.

The combustor assembly 200 is located within a plenum 208 of the engine 202 that encircles the center axis 206. The combustor assembly 200 includes an inner wall 210 and an outer wall 212 that both extend around and/or encircle the center axis 206. The inner and outer walls 210, 212 encircle the center axis 206 to form an annular space (referred to herein as a main chamber 214) around the center axis 206. Exhaust from combustions within the combustor assembly 200 flows out of the combustor assembly 200 through the main chamber 214.

The inner and outer walls 210, 212 are radially spaced apart from each other (in directions radially extending away from the center axis 206). As a result, the walls 210, 212 do not touch each other with the inner wall 210 being closer to the center axis 206 than the outer wall 212. As shown in FIG. 2, both the inner and outer walls 210, 212 are contained within the engine 202.

Air is received into the engine 202 through an inlet 220 of the engine 202. The inner wall 210 optionally includes a chute 224 through which additional air can be introduced into the main chamber 214. The chute 224 is an opening or additional inlet that receives air in the engine 202 into the main chamber 214. The chute 224 can be shaped as a slot that is longer along one direction and is shorter along a different, orthogonal direction. Alternatively, the chute 224 can have another shape, such as a circle, oval, square, or the like.

The combustor assembly 200 also includes a leading cavity wall 216 and a trailing cavity wall 218. The cavity walls 216, 218 oppose each other and are axially spaced apart from each other in directions along or parallel to the center axis 206. The leading cavity wall 216 is located closer to the inlet 220 of the engine 202 than the trailing cavity wall 218. Each of the walls 216, 218 can have an annular or ring shape that encircles the center axis 206. The leading cavity wall 216 is joined with (or transitions into) a leading end 232 of the inner wall 210. The trailing cavity wall 218 is joined with (or transitions into) a leading end 232 of the outer wall 212. Each of the leading cavity wall 216 and the trailing cavity wall 218 radially extend away from the corresponding inner and outer walls 210, 212.

The combustor assembly 200 also includes an axial wall 222 that is coupled with and connects the leading and trailing cavity walls 216, 218 with each other. The axial wall 222 can have the shape of a ring that encircles the center axis 206. The axial wall 222 axially extends parallel to the center axis 206 from one wall 216 or 218 to the other wall 216, 218. The axial wall 222, leading and trailing cavity walls 216, 218, and the inner and outer walls 210, 212 define the combustor assembly 200. The cavity 204 is bounded by the axial wall 222, the cavity walls 216, 218, and the inner and outer walls 210, 212, as shown in FIG. 2.

The combustor assembly 200 has a curved and elongated shape that extends from an inlet end 226 to an opposite exhaust outlet end 228. The inlet end 226 is defined by the axial wall 222 and the outlet end 228 is defined by ends of the inner and outer walls 210, 212 that are opposite to the ends of the inner and outer walls 210, 212 that join with the cavity walls 216, 218. The axial wall 222 includes cavity inlets for receiving both air and fuel into the cavity 204, as described in more detail below. Detonations of the engine 202 occur in the cavity 204. Due at least in part to the shape and/or orientation of the cavity inlets 230, the detonations occurring in the cavity 204 rotate around the center axis 206. The detonations are stabilized within the cavity 204 such that the detonations occur in the cavity 204 and/or the speed at which detonations move around the center axis 206 in the cavity 204 reaches a steady state (e.g., does not change by more than a designated amount, such as 10%, 5%, 3%, or 1%). The cavity 204 can be referred to as a detonation stabilizing cavity.

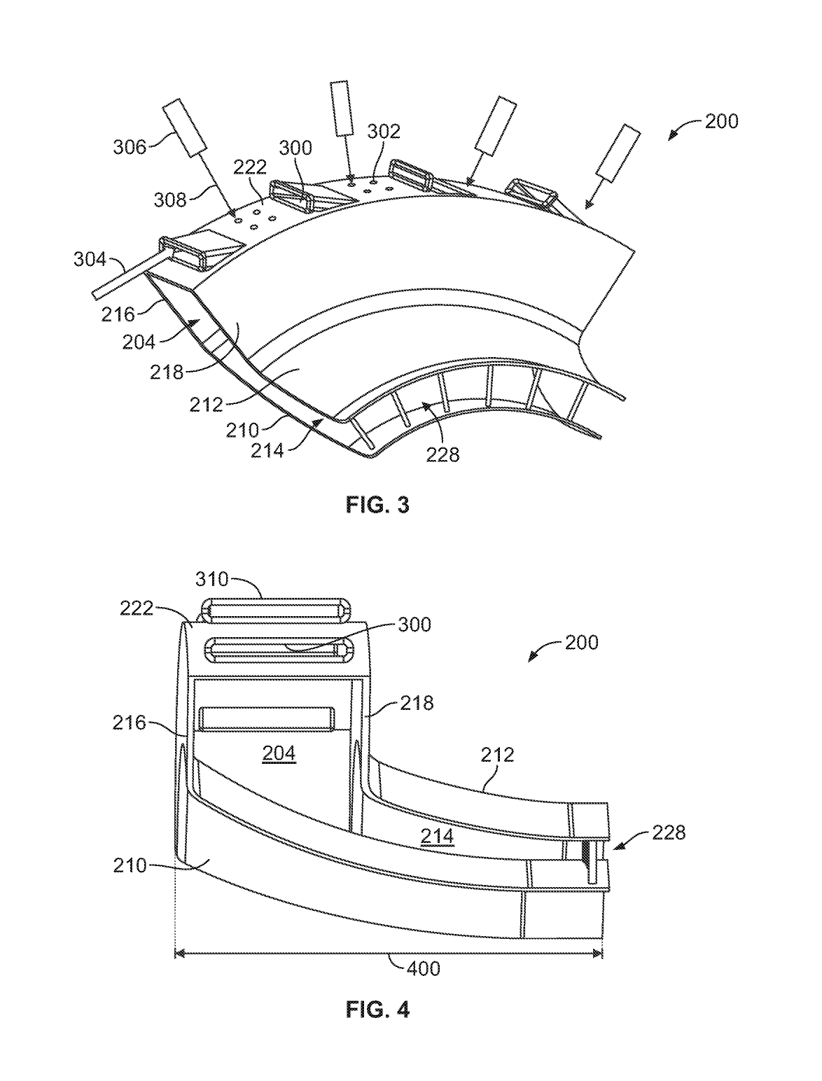

FIG. 3 illustrates a perspective view of a portion of the combustor assembly 200 shown in FIG. 2. FIG. 4 illustrates a cross-sectional view of the combustor assembly 200 shown in FIG. 2. The cavity inlets referred to above include air openings 300 and fuel openings 302. The air openings 300 are elongated slots and the fuel openings 302 are circular openings (or openings of another shape) that extend through the axial wall 222 of the combustor assembly 200. Alternatively, the air openings 300 can be circular or have another shape. Air 304 flows through the inlet 220 of the engine 202 (shown in FIG. 2) and into the cavity 204 through the air openings 300. Fuel injectors 306 are disposed outside of the combustor assembly 200 and oriented to inject fuel 308 into the cavity 204 through the fuel openings 302.

The fuel openings 302 shown in FIG. 3 are shown schematically as the fuel openings 302 may be so small as to not be visible in FIG. 3. As shown in FIG. 3, the air openings 300 may be spaced apart along an outer circumference of the axial wall 222 in a regular or repeating pattern with the fuel openings 302 disposed between neighboring air openings 300. Optionally, another arrangement of the air openings 300 and/or fuel openings 302 can be provided.

The fuel and air received into the cavity 204 mixes and combusts within the cavity 204, as referred to above. The detonation of the fuel and air mixture in the cavity 204 moves around in the cavity 204 in a direction that swirls around the center axis 206 and eventually exits the combustor assembly 200 through the outlet end 228. The air openings 300 are elongated slots having longest dimensions (e.g., the outer distance from one end of the slot to the opposite end of the slot) that are oriented parallel to the center axis 206 of the engine 202 (shown in FIG. 2). The axial wall 222 can have hood extensions 310 that partially project outward from the axial wall 222. The hood extensions 310 are angled bodies that direct or funnel air 304 into the combustor assembly 200.

As shown in FIG. 3, the hood extensions 310 are shaped and positioned such that the hood extensions 310 outwardly project from the axial wall 222 in directions that are transverse to the axial wall 222. The extensions 310 also project from the axial wall 222 in directions that are transverse to the directions in which fuel 308 is received into the cavity 204 of the combustor assembly 200. The extensions 310 are shaped so that air 304 flowing into the cavity 204 through the air openings 300 is moving in directions that are tangential to the axial wall 222 or in directions that are closer to tangential directions to the axial wall 222 (than directions that are perpendicular to the axial wall 222). The fuel 308 is directed into the cavity 204 in radial directions, such as directions that extend toward the center axis 206.

The fuel 308 and air 304 are introduced into the cavity 204 in different directions (e.g., a swirling direction for the air 304 and a radial direction for the fuel 308), thereby creating an air curtain in which the fuel is carried that swirls around the center axis 206. For example, this air curtain may carry fuel and rotate around the center axis 206 in the cavity 204.

The hood extensions 310 are shaped to direct the air 304 into the cavity 204 in directions that cause the air 304 (and fuel 308) to swirl around within the cavity 204 around the center axis 206. This swirling motion of the air 304 and fuel 308 causes the detonations of the air 304 and fuel 308 to be stabilized within the cavity 204 and causes the detonations to move in the cavity 204 and rotate around the center axis 206. The detonations rotate within the cavity 204 without moving parts in the combustor assembly 200. The rotation of the air 304 and fuel 308 also can cause the exhaust to rotate around the center axis 206 as the exhaust flows out of the exhaust outlet end 228 and into the plenum 208 (shown in FIG. 2) of the engine 202. This rotation of the exhaust can obviate or eliminate the need for a stage one nozzle in the engine 202 that otherwise would rotate the exhaust coming out of the combustor assembly 200.

As shown in FIG. 2, the separation between the inner and outer walls 210, 212 decreases in locations of the combustor assembly 200 that are closer to the outlet end 228 than the cavity 204 or the cavity walls 216, 218. The inner and outer walls 210, 212 are tapered and are closer together toward the outlet end 228 to form a funnel that focuses the exhaust carried in the main chamber 214 of the combustor assembly 200 toward the outlet end 228. This shape reduces the diameter of the annulus formed by the combustor assembly 200 at the outlet end 228 relative to other locations of the combustor assembly 200. The funnel or focusing shape of the inner and outer walls 210, 212 focuses the flows of exhaust within the combustor assembly 200, which preserves or maintains the swirling or rotating movement of gases within the combustor assembly 200, thereby eliminating the need for the stage one nozzle in the engine 202 (or at least reduces the size of the stage one nozzle that is used with the combustor assembly 200).

The total length of the combustor assembly 200 may be relatively small when compared to other combustors of rotating detonation engines. For example, a total axial length 400 of the combustor assembly 200 (shown in FIG. 4) can be measured from the axial wall 222 to the outlet end 228 in a direction that is parallel to the center axis 206. This length 400 may be significantly shorter than axial lengths (measured in the same way) of other combustors for rotating detonation engines, such as no more than one third of the axial lengths of known combustors. In one embodiment, the length 400 may be no more than thirteen centimeters (e.g., approximately five inches).

The shorter length or smaller size of the combustor assembly 200 also may yield reduced generation of emissions (e.g., NOx) relative to longer or larger combustors in rotating detonation engines. For example, the shorter length 400 of the combustor assembly 200 can reduce the residence time of the exhaust in the combustor assembly 200, which can reduce the emissions generated by operation of the combustor assembly 200.

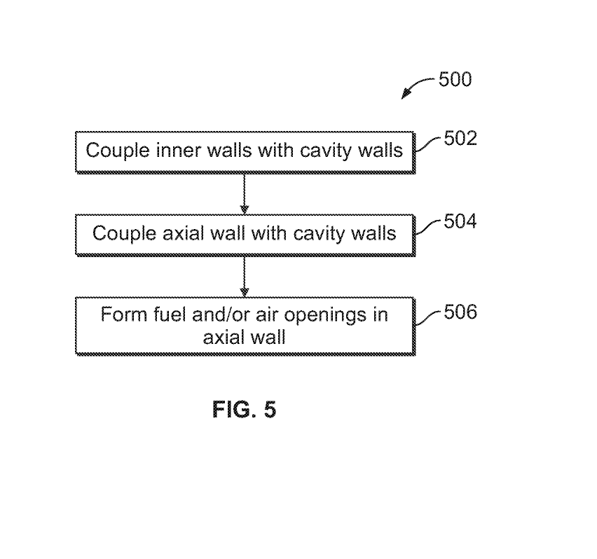

FIG. 5 illustrates a flowchart of one embodiment of a method 500 for providing a cavity stabilized detonation combustor assembly of a rotation detonation engine. The method 500 can be used to create one or more embodiments of the combustor assembly 200 shown and described herein. At 502, annular-shaped inner and outer walls are coupled with annular-shaped cavity walls. For example, the inner and outer walls 210, 212 are connected with the cavity walls 216, 218. At 504, an axial wall is coupled with the cavity walls to connect the inner wall, outer wall, and cavity walls with each other. The axial wall 222 can be coupled with the cavity walls 216, 218 on ends of the cavity walls 216, 218 that are opposite to the ends that are coupled with the inner and outer walls 210, 212.

At 506, one or more air openings and fuel openings are formed in the axial wall. Optionally, the air and/or fuel openings may be formed in the axial wall prior to coupling the axial wall with the cavity walls. As described above, the air openings and the fuel openings can be shaped and oriented to direct air and fuel into the combustor assembly in different (e.g., perpendicular or near perpendicular) directions and with the air creating a swirling air curtain inside the combustor assembly.

In one embodiment, a cavity stabilized detonation combustor assembly for a rotating detonation engine includes opposing inner and outer walls that are radially spaced apart from each other and that both extend around a center axis of the rotating detonation engine. Detonations in the rotating detonation engine rotate around the center axis of the rotating detonation engine. The assembly also includes opposing leading and trailing cavity walls that are coupled with the inner and outer walls and which radially extend away from the center axis, and an axial wall that is coupled with and connects the leading and trailing cavity walls with each other. The axial wall and the leading and trailing cavity walls define a detonation stabilizing cavity in which detonations of the rotating detonation engine occur and are stabilized.

Optionally, the axial wall includes fuel openings through which fuel is injected into the detonation stabilizing cavity and air openings through which air is injected into the detonation stabilizing cavity. The air openings can be oriented to direct the air into the detonation stabilizing cavity in tangential directions that rotate the air in the detonation stabilizing cavity around the center axis of the rotating detonation engine.

Optionally, the fuel openings in the axial wall are oriented to direct the fuel into the detonation stabilizing cavity in normal radial directions toward the center axis of the rotating detonation engine.

Optionally, the fuel openings in the axial wall are oriented to direct the fuel into the detonation stabilizing cavity in a direction that is transverse to the tangential directions in which the air is directed into the detonation stabilizing cavity by the air openings.

Optionally, the air openings in the axial wall are slots elongated in axial directions that are parallel to the center axis of the rotating detonation engine.

Optionally, the inner and outer walls have a tapered shape with the inner and outer walls being spaced apart by a larger distance at leading ends of the inner and outer walls than at opposite trailing ends of the inner and outer walls.

Optionally, the tapered shape of the inner and outer walls focuses exhaust flow from the detonation stabilizing cavity toward an annular plenum of the rotating detonation engine.

In one embodiment, a cavity stabilized detonation combustor assembly for a rotating detonation engine includes opposing inner and outer walls that are radially spaced apart from each other and that both extend around a center axis of the rotating detonation engine. Detonations in the rotating detonation engine rotate around the center axis of the rotating detonation engine. The assembly also includes opposing leading and trailing cavity walls that are coupled with the inner and outer walls and which radially extend away from the center axis, and an axial wall that is coupled with and connects the leading and trailing cavity walls with each other. The axial wall includes fuel openings through which fuel is injected into the detonation stabilizing cavity and air openings through which air is injected into the detonation stabilizing cavity. The air openings are oriented to direct the air into the detonation stabilizing cavity in tangential directions that rotate the air in the detonation stabilizing cavity around the center axis of the rotating detonation engine.

Optionally, the axial wall and the leading and trailing cavity walls define a detonation stabilizing cavity in which detonations of the rotating detonation engine occur and are stabilized.

Optionally, a total axial length dimension of the combustor assembly from the leading cavity wall to opposite ends of the inner and outer walls is no greater than thirteen centimeters.

Optionally, the axial wall and the leading and trailing cavity walls define a detonation stabilizing cavity, where the fuel openings in the axial wall can be oriented to direct the fuel into the detonation stabilizing cavity in normal radial directions toward the center axis of the rotating detonation engine.

Optionally, the axial wall and the leading and trailing cavity walls define a detonation stabilizing cavity, and the fuel openings in the axial wall can be oriented to direct the fuel into the detonation stabilizing cavity in a direction that is transverse to the tangential directions in which the air is directed into the detonation stabilizing cavity by the air openings.

Optionally, the air openings in the axial wall are slots elongated in axial directions that are parallel to the center axis of the rotating detonation engine.

Optionally, the inner and outer walls have a tapered shape with the inner and outer walls being spaced apart by a larger distance at leading ends of the inner and outer walls than at opposite trailing ends of the inner and outer walls.

In one embodiment, a cavity stabilized detonation combustor assembly for a rotating detonation engine includes opposing inner and outer walls that are radially spaced apart from each other and that both extend around a center axis of the rotating detonation engine. Detonations in the rotating detonation engine rotate around the center axis of the rotating detonation engine. The assembly also includes opposing leading and trailing cavity walls that are coupled with the inner and outer walls and which radially extend away from the center axis, and an axial wall that is coupled with and connects the leading and trailing cavity walls with each other. The inner and outer walls have a tapered shape with the inner and outer walls being spaced apart by a larger distance at leading ends of the inner and outer walls than at opposite trailing ends of the inner and outer walls.

Optionally, the axial wall and the leading and trailing cavity walls define a detonation stabilizing cavity in which detonations of the rotating detonation engine occur and are stabilized.

Optionally, the axial wall includes fuel openings through which fuel is injected into the detonation stabilizing cavity and air openings through which air is injected into the detonation stabilizing cavity. The air openings can be oriented to direct the air into the detonation stabilizing cavity in tangential directions that rotate the air in the detonation stabilizing cavity around the center axis of the rotating detonation engine.

Optionally, the fuel openings in the axial wall are oriented to direct the fuel into the detonation stabilizing cavity in normal radial directions toward the center axis of the rotating detonation engine.

Optionally, the fuel openings in the axial wall are oriented to direct the fuel into the detonation stabilizing cavity in a direction that is transverse to the tangential directions in which the air is directed into the detonation stabilizing cavity by the air openings.

Optionally, the air openings in the axial wall are slots elongated in axial directions that are parallel to the center axis of the rotating detonation engine.

This written description uses examples to disclose the inventive subject matter, including the best mode, and also to enable a person of ordinary skill in the art to practice the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they include structural elements that do not differ from the literal language of the claims, or if they include equivalent structural elements with insubstantial differences from the literal languages of the claims.

What is claimed is:

1. A cavity stabilized detonation combustor assembly for a rotating detonation engine, the combustor assembly comprising:
opposing inner and outer walls that are radially spaced apart from each other and that both extend around a center axis of the rotating detonation engine, wherein detonations in the rotating detonation engine rotate around the center axis of the rotating detonation engine;
opposing leading and trailing cavity walls that are coupled with the inner and outer walls and which radially extend away from the center axis; and
an axial wall that is coupled with and connects the leading and trailing cavity walls with each other, the axial wall and the leading and trailing cavity walls defining a detonation stabilizing cavity in which detonations of the rotating detonation engine occur and are stabilized.

2. The combustor assembly of claim 1, wherein the axial wall includes fuel openings through which fuel is injected into the detonation stabilizing cavity and air openings through which air is injected into the detonation stabilizing cavity, wherein the air openings are oriented to direct the air into the detonation stabilizing cavity in tangential directions that rotate the air in the detonation stabilizing cavity around the center axis of the rotating detonation engine.

3. The combustor assembly of claim 2, wherein the fuel openings in the axial wall are oriented to direct the fuel into the detonation stabilizing cavity in normal radial directions toward the center axis of the rotating detonation engine.

4. The combustor assembly of claim 2, wherein the fuel openings in the axial wall are oriented to direct the fuel into the detonation stabilizing cavity in a direction that is transverse to the tangential directions in which the air is directed into the detonation stabilizing cavity by the air openings.

5. The combustor assembly of claim 2, wherein the air openings in the axial wall are slots elongated in axial directions that are parallel to the center axis of the rotating detonation engine.

6. The combustor assembly of claim 1, wherein the inner and outer walls have a tapered shape with the inner and outer walls being spaced apart by a larger distance at leading ends of the inner and outer walls than at opposite trailing ends of the inner and outer walls.

7. The combustor assembly of claim 6, wherein the tapered shape of the inner and outer walls focuses exhaust flow from the detonation stabilizing cavity toward an annular plenum of the rotating detonation engine.

8. A cavity stabilized detonation combustor assembly for a rotating detonation engine, the combustor assembly comprising:
opposing inner and outer walls that are radially spaced apart from each other and that both extend around a center axis of the rotating detonation engine, wherein detonations in the rotating detonation engine rotate around the center axis of the rotating detonation engine;
opposing leading and trailing cavity walls that are coupled with the inner and outer walls and which radially extend away from the center axis; and
an axial wall that is coupled with and connects the leading and trailing cavity walls with each other, the axial wall including fuel openings through which fuel is injected into the detonation stabilizing cavity and air openings through which air is injected into the detonation stabilizing cavity,
wherein the air openings are oriented to direct the air into the detonation stabilizing cavity in tangential directions that rotate the air in the detonation stabilizing cavity around the center axis of the rotating detonation engine.

9. The combustor assembly of claim 8, wherein the axial wall and the leading and trailing cavity walls define a detonation stabilizing cavity in which detonations of the rotating detonation engine occur and are stabilized.

10. The combustor assembly of claim 8, wherein a total axial length dimension of the combustor assembly from the leading cavity wall to opposite ends of the inner and outer walls is no greater than thirteen centimeters.

11. The combustor assembly of claim 8, wherein the axial wall and the leading and trailing cavity walls define a detonation stabilizing cavity and wherein the fuel openings in the axial wall are oriented to direct the fuel into the detonation stabilizing cavity in normal radial directions toward the center axis of the rotating detonation engine.

12. The combustor assembly of claim 8, wherein the axial wall and the leading and trailing cavity walls define a detonation stabilizing cavity and wherein the fuel openings in the axial wall are oriented to direct the fuel into the detonation stabilizing cavity in a direction that is transverse to the tangential directions in which the air is directed into the detonation stabilizing cavity by the air openings.

13. The combustor assembly of claim 8, wherein the air openings in the axial wall are slots elongated in axial directions that are parallel to the center axis of the rotating detonation engine.

14. The combustor assembly of claim 8, wherein the inner and outer walls have a tapered shape with the inner and outer walls being spaced apart by a larger distance at leading ends of the inner and outer walls than at opposite trailing ends of the inner and outer walls.

15. A cavity stabilized detonation combustor assembly for a rotating detonation engine, the combustor assembly comprising:
opposing inner and outer walls that are radially spaced apart from each other and that both extend around a center axis of the rotating detonation engine, wherein detonations in the rotating detonation engine rotate around the center axis of the rotating detonation engine;
opposing leading and trailing cavity walls that are coupled with the inner and outer walls and which radially extend away from the center axis; and
an axial wall that is coupled with and connects the leading and trailing cavity walls with each other, wherein the inner and outer walls have a tapered shape with the inner and outer walls being spaced apart by a larger distance at leading ends of the inner and outer walls than at opposite trailing ends of the inner and outer walls.

16. The combustor assembly of claim 15, wherein the axial wall and the leading and trailing cavity walls define a detonation stabilizing cavity in which detonations of the rotating detonation engine occur and are stabilized.

17. The combustor assembly of claim 15, wherein the axial wall includes fuel openings through which fuel is injected into the detonation stabilizing cavity and air openings through which air is injected into the detonation stabilizing cavity, wherein the air openings are oriented to direct the air into the detonation stabilizing cavity in tangential directions that rotate the air in the detonation stabilizing cavity around the center axis of the rotating detonation engine.

18. The combustor assembly of claim 17, wherein the fuel openings in the axial wall are oriented to direct the fuel into the detonation stabilizing cavity in normal radial directions toward the center axis of the rotating detonation engine.

19. The combustor assembly of claim 17, wherein the fuel openings in the axial wall are oriented to direct the fuel into the detonation stabilizing cavity in a direction that is transverse to the tangential directions in which the air is directed into the detonation stabilizing cavity by the air openings.

20. The combustor assembly of claim 17, wherein the air openings in the axial wall are slots elongated in axial directions that are parallel to the center axis of the rotating detonation engine.
